(19) United States
(12) Patent Application Publication
(10) Pub. No.: US 2013/0122352 A1
(43) Pub. Date: May 16, 2013

(54) SINTERED NICKEL POSITIVE ELECTRODE, METHOD FOR MANUFACTURING THE SAME, AND ALKALINE STORAGE BATTERY INCLUDING THE SINTERED NICKEL POSITIVE ELECTRODE

(71) Applicants: Yasuyuki Harada, Naruto City (JP); Yasuhiro Kudo, Itano-gun Kitajima-cho (JP); Kenji Fujita, Itano-gun Matsushige-cho (JP); Toshihiro Sakatani, Itano-gun Kitajima-cho (JP); Makoto Mori, Itano-gun Matsushige-cho (JP); Teruhito Nagae, Tokushima City (JP)

(72) Inventors: Yasuyuki Harada, Naruto City (JP); Yasuhiro Kudo, Itano-gun Kitajima-cho (JP); Kenji Fujita, Itano-gun Matsushige-cho (JP); Toshihiro Sakatani, Itano-gun Kitajima-cho (JP); Makoto Mori, Itano-gun Matsushige-cho (JP); Teruhito Nagae, Tokushima City (JP)

(73) Assignee: SANYO ELECTRIC CO., LTD., Moriguchi City, Osaka (JP)

(21) Appl. No.: 13/811,672

(22) PCT Filed: Jul. 26, 2011
(86) PCT No.: PCT/JP2011/066970

§ 371 Date: Jan. 23, 2013

(30) Foreign Application Priority Data
Jul. 30, 2010 (JP) 2010-172533

(51) Int. Cl. H01M 4/04

(52) U.S. Cl. CPC H01M 4/0416
USPC 429/163; 427/58; 429/223

(57) ABSTRACT

Disclosed is a sintered nickel positive electrode that has an expanded usable range to a low charging region by using nickel hydroxide having a particular crystal structure as a main component of a positive electrode active material.

In the sintered nickel positive electrode of the invention, a nickel sintered substrate is filled, through a plurality of impregnation steps, with a positive electrode active material containing nickel hydroxide (β-Ni(OH)₂) as a main component. In addition, the nickel hydroxide (β-Ni(OH)₂) has an integrated intensity ratio of a peak intensity in a (001) face of 1.8 or more with respect to a peak intensity in a (100) face, where the peak intensities are determined by X-ray diffraction analysis, while an integrated intensity ratio of a peak intensity in a (001) face with respect to a peak intensity in a (100) face is about 1.5 in the related art. Using the nickel hydroxide having an integrated intensity ratio of the peak intensity in the (001) face of 1.8 or more with respect to the peak intensity in the (100) face enables high-rate continuous discharge in a low charging region.

### TECHNICAL FIELD

The present invention relates to a sintered nickel positive electrode for alkaline storage batteries that are suitably used in vehicles such as hybrid electric vehicles (HEVs), a method for manufacturing the electrode, and an alkaline storage battery including the sintered nickel positive electrode.

### BACKGROUND ART

In recent years, secondary batteries have been applied to various products such as cell phones, personal computers, power tools, hybrid electric vehicles (HEVs), and pure electric vehicles (PEVs), and an alkaline storage battery is used for these applications. Among them, the alkaline storage battery used for consumer applications such as cell phones, personal computers, and power tools uses a non-sintered nickel positive electrode including a metal substrate such as a punching metal and a foamed metal in place of a nickel sintered substrate for reasons of high capacity. In contrast, the alkaline storage battery used in vehicles such as hybrid electric vehicles (HEVs) uses a sintered nickel positive electrode including a nickel sintered substrate for reasons of usage in that the nickel sintered substrate readily achieves a longer battery life.

A sintered nickel positive electrode is typically prepared as follows: a porous nickel sintered substrate is chemically impregnated with a nickel salt such as nickel nitrate; the nickel salt is treated with an aqueous alkali solution to be converted into an active material; and consequently pores in the porous nickel sintered substrate are filled with nickel hydroxide as the active material. Such a sintered nickel positive electrode uses a nickel sintered substrate formed by closely sintering nickel particles to each other. Thus, a sintered nickel positive electrode has higher electric conductivity than a non-sintered nickel positive electrode, the conductive distance in the nickel positive electrode is shorter, and the adhesion between nickel hydroxide used as an active material and the nickel sintered substrate is better. Hence, the sintered nickel positive electrode has advantages of excellent electric current collection performance and excellent charge-discharge characteristics at high electric current.

Meanwhile, in this kind of sintered nickel positive electrode, the oxygen gas evolution potential is close to the charge reaction potential. In particular, the oxygen gas evolution potential (namely, oxygen overvoltage) decreases at a high temperature, leading to competition between the oxidation reaction of a nickel active material and the oxygen gas evolution reaction during charging. Hence, charge acceptance deteriorates, which causes the problem of reduced battery performance at a high temperature. Thus, Patent Documents 1 to 3 and other documents disclose techniques of using additional elements such as Ca, Sr, Y, Al, and Mn to increase the oxygen overvoltage, thereby improving the charge acceptance. In this case, the addition position of these additional elements (position at which these elements are added) is on the surface of nickel hydroxide (Ni(OH)₂) used as an active material so that a larger amount of the element is present close to the interface with an electrolyte. This improves the effect of increasing the oxygen overvoltage.

However, disposing such an additional element on the surface of a nickel hydroxide (Ni(OH)₂) active material raises the problem of inhibiting charge-discharge reaction of the active material. The degree of inhibition of the charge-discharge reaction is larger when the additional element is disposed on the surface of a sintered nickel positive electrode than when the additional element is uniformly disposed throughout the sintered nickel positive electrode. At the time of charging at high temperature, the difference between the charging potential and the oxygen evolution potential is small. Hence, when such an additional element is disposed on the surface of a sintered nickel positive electrode, the increasing effect on the oxygen overvoltage is large enough to suppress the evolution of oxygen gas, thereby improving the charge acceptance.

However, at the time of charging at ambient temperature, the difference between the charging potential and the oxygen evolution potential is large. Hence, even when such an additional element is disposed on the surface of a sintered nickel positive electrode, the increasing effect on the oxygen overvoltage is not achieved and conversely, the problem of inhibiting the charge-discharge reaction by the additional element on the surface of the sintered nickel positive electrode affects battery performance. The additional element on the surface of the sintered nickel positive electrode consequently works as a resistance component, raising the problem of further increasing the influence at the time of charging and discharging at high current. Thus, Patent Document 4 discloses that coating the surface of a nickel sintered substrate with an oxide containing cobalt can suppress the deterioration of high current charge characteristics and high current discharge characteristics even when the additional element as above is disposed on the surface of a positive electrode active material.

### RELATED ART DOCUMENTS

### Patent Documents

[Patent Document 1] JP-A-11-73957
[Patent Document 2] JP-A-10-125318
[Patent Document 3] JP-A-10-149821
[Patent Document 4] JP-A-2002-184399

### DISCLOSURE OF INVENTION

### Problem to be Solved by the Invention

However, an active material resistance increases in a low charging region even when a sintered nickel positive electrode in which the surface of a nickel sintered substrate is coated with an oxide containing cobalt is used. This is because, in a low charging region, the increase in the amount of nickel hydroxide (β-Ni(OH)₂) having low electric conductivity with respect to that of nickel oxyhydroxide (β-NiOOH) lowers the electronic conductivity in the active material to which the electric conductivity of an active material itself contributes. Therefore, high-rate continuous discharge performance is not enough. In particular, in the application in vehicles such as hybrid electric vehicles (HEVs), an intermediate region of the battery capacity is used. Thus, the discharge performance in a low charging region deteriorates (the high-rate continuous discharge performance in an intermediate region of the battery capacity deteriorates), raising the problem of limiting the range of use. On this account, there has arisen a demand for suppressing such a deterioration of discharge performance in a low charging region, for improving the high-rate continuous discharge performance in an intermediate region of the battery capacity, and for expanding the usable range to a low charging region.

Based on such a demand, the inventors of the invention have studied various methods for improving such a high-rate continuous discharge performance in an intermediate region of the battery capacity and for expanding the usable range to a low charging region. As a result, they have found that in a sintered nickel positive electrode, the difference in crystal structure of nickel hydroxide as a main active material leads to the difference in continuous discharge performance.

Therefore, the invention is based on such a finding and has an object to provide a sintered nickel positive electrode that has an expanded usable range to a low charging region by using nickel hydroxide (β-Ni(OH)₂) having a particular crystal structure as the main component of the positive electrode active material and to provide an alkaline storage battery that has an improved high-rate continuous discharge performance in an intermediate region of the battery capacity and is best suited for application to vehicles such as hybrid electric vehicles (HEVs).

### Means for Solving Problem

To achieve the object, a sintered nickel positive electrode of the invention includes a nickel sintered substrate filled, through a plurality of impregnation steps, with a positive electrode active material containing nickel hydroxide (β-Ni(OH)₂) as a main component. In the sintered nickel positive electrode, the nickel hydroxide (β-Ni(OH)₂) has an integrated intensity ratio of a peak intensity in a (001) face of 1.8 or more with respect to a peak intensity in a (100) face, where the peak intensities are determined by X-ray diffraction analysis. Here, it has been revealed that high-rate continuous discharge can be performed even in a low charging region by specifying the nickel hydroxide (β-Ni(OH)₂) to have an integrated intensity ratio of the peak intensity in the (001) face of 1.8 or more with respect to the peak intensity in the (100) face, which is about 1.5 in related art.

This is thought to have occurred because protons could readily move even in a low SOC condition (for example, an SOC of 20%) due to the integrated intensity ratio of the peak intensity in the (001) face of 1.8 or more with respect to the peak intensity in the (100) face, which is larger than about 1.5, which is a general ratio. The sintered nickel positive electrode is a mixture with a nickel sintered substrate. Thus, the absolute intensity of nickel hydroxide (β-Ni(OH)₂) varies depending on the ratio of nickel powder and nickel hydroxide (β-Ni(OH)₂) as the positive electrode active material in an X-ray irradiation area, and also varies depending on the packing density of the positive electrode active material (β-Ni(OH)₂) and the density of the nickel powder in the nickel sintered substrate. On this account, it is necessary to compare intensities in terms of relative intensity.

A method for filling a nickel sintered substrate with the nickel hydroxide (β-Ni(OH)₂) having an integrated intensity ratio of a peak intensity in a (001) face of 1.8 or more with respect to a peak intensity in a (100) face, where the peak intensities are determined by X-ray diffraction analysis, includes the following: impregnating pores in the nickel sintered substrate with a nitrate salt by immersing the nickel sintered substrate in a nitrate salt solution; alkali-treating the nickel sintered substrate impregnated with the nitrate salt to convert the nitrate salt into nickel hydroxide (β-Ni(OH)₂) as an active material; adjusting the alkali amount of the nickel sintered substrate alkali-treated; and heating the nickel sintered substrate having the alkali amount adjusted to convert the nickel hydroxide as the active material into a high-order compound. In the method, a series of steps of the impregnating, the alkali-treating, the adjusting of the alkali amount, and the heating are repeated until a particular amount of the active material is filled.

In the series of steps as above, when the aqueous alkali solution used in the alkali-treating has a high concentration (alkali content) (the amount of alkali is large), for example, the alkali may be fixed to the nickel sintered substrate as an alkali residue, or the alkali may react with a nitrate salt, with which the next impregnating is performed, to form a smudge adhering onto the surface of a nickel sintered substrate. Such a fixed substance or a smudge on the surface of a nickel sintered substrate may form as a protrusion. During the subsequent impregnating, this interferes with removal of gas generated in the substrate, causing the active material to fall off, resulting in a short-circuit or other defects in the worst cases. Thus, the alkali concentration (alkali amount) at the time of heating must be adjusted.

For this reason, the series of steps of impregnating with a nitrate salt, alkali-treating (the forming of an active material), adjusting of the alkali amount, and heating must be performed. It has been revealed that in this case, the effect cannot be provided when the adjusting of the alkali amount is partially introduced; for example, in an intermediate step alone among the series of steps or in the last step alone among the series of steps. This is thought to occur because stacked active material is formed in the sintered nickel positive electrode while repeating the impregnation twice or more in filling with an active material, and an area in which the alkali amount is not adjusted determines the rate of reaction at a low state of charge.

Here, the adjusting of the alkali amount (the adjusting of the alkali concentration) is desirably performed by a method of washing a part of the nickel sintered substrate because it is performed after the alkali-treating. As an example, the alkali concentration can be adjusted to a particular concentration by controlling the period of time for immersing a nickel sintered substrate after being alkali-treated in a water bath. Alternatively, the concentration can be adjusted by immersing a nickel sintered substrate in an aqueous alkali solution having a particular concentration (an aqueous alkali solution having a lower concentration than that of the solution used for the alkali-treating) for a particular period of time.

In the adjusting of the alkali amount (the adjusting of the alkali concentration), the alkali concentration in a nickel sintered substrate (the alkali concentration in an active material that is calculated by examining the Na content) is preferably adjusted to 0.5% to 2.2% and more preferably from 1.5% to 2.0%. This is because a nickel sintered substrate having an alkali concentration of 0.1% or less cannot provide the effect and a nickel sintered substrate having an alkali concentration of 2.3% or more results in a marked smudge on the electrode sheet.

Meanwhile, various conditions in the heating can be designed depending on the combination of temperature and time. The temperature is desirably 80° C. or more and 150° C. or less. The treatment time is desirably 10 minutes or more and more preferably 30 minutes or more.

### Effect of the Invention

In the invention, a nickel hydroxide having a particular crystal structure is used as a main active material. Thus, a sintered nickel positive electrode that can perform high-rate continuous discharge even in a low charging region can be obtained. Using such a sintered nickel positive electrode can improve the high-rate continuous discharge performance in an intermediate region of the battery capacity, thereby providing an alkaline storage battery suitably used in vehicles such as hybrid electric vehicles (HEVs).

### BRIEF DESCRIPTION OF DRAWINGS

FIG. 1 is a view showing X-ray diffraction charts of sintered nickel positive electrodes a1 to a4.

FIG. 2 is a view showing X-ray diffraction charts of sintered nickel positive electrodes b1 to b3.

### BEST MODE(S) FOR CARRYING OUT THE INVENTION

Embodiments of the invention will next be described in detail hereinafter, but the invention is not limited to the embodiments. Various changes and modifications may be made in the invention as appropriate, without departing from the spirit and scope of the invention.

1. Nickel Sintered Substrate

The nickel sintered substrate used was prepared as follows. Specifically, 40 parts by mass of nickel powder (for example, having a bulk density of 0.57 g/cm³ and a Fisher size of from 2.2 to 2.8 μm) was mixed to 60 parts by mass of 3% by mass methyl cellulose (MC) solution, and the whole was kneaded while drawing a vacuum, thereby preparing a nickel slurry. Next, the nickel slurry thus obtained was applied onto both sides of punching metal of a nickel-plated steel plate so as to give a particular thickness. After drying the plate, the plate was sintered in a reducing atmosphere at 1,000° C. for 10 minutes, thereby preparing a nickel sintered substrate a having a porosity of 86% and a thickness of 0.40 mm.

Subsequently, cobalt nitrate and nickel nitrate were dissolved in pure water at a molar ratio of 1:1 to prepare a nitrate salt solution adjusted to have a specific gravity of 1.30. The nickel sintered substrate a prepared as above was immersed in the nitrate salt solution at a temperature of 25° C. (immersing in nitrate salts) to impregnate pores of the nickel sintered substrate with the nitrate salts. Next, the substrate was dried at 50° C. for 30 minutes, and then was immersed in an aqueous sodium hydroxide solution having a concentration of 8.0 mol/l at a temperature of 80° C. for 30 minutes to be subjected to alkali treatment (alkali-treating). The nitrate salts with which pores of the nickel sintered substrate had been impregnated were converted into hydroxides. Next, the alkali-treated nickel sintered substrate was immersed in a water bath for 16 seconds, and then was heated at a surrounding temperature adjusted to 100 to 130° C. for 60 minutes, thereby preparing a nickel sintered substrate β coated with a high order oxide layer of nickel and cobalt.

2. Sintered Nickel Positive Electrode

(1) Sintered Nickel Positive Electrode a1

Next, using the nickel sintered substrate β coated with the high order oxide layer of nickel and cobalt, the treatment steps (a) to (e) below were repeated a particular number of times (in this case, three times) to fill pores of the nickel sintered substrate β with a particular amount of a positive electrode active material. Subsequently, the substrate was dried at 80° C. for 60 minutes to prepare a sintered nickel positive electrode in which the pores of the nickel sintered substrate β were filled with the positive electrode active material. The sintered nickel positive electrode thus obtained was regarded as a sintered nickel positive electrode a1.

The treatment steps (a) to (e) are as follows.

### (a) Nitrate Salt Impregnating

Nickel nitrate, cobalt nitrate, and zinc nitrate are mixed at a molar ratio of 94:3:3 to prepare an aqueous nickel nitrate solution (a specific gravity of 1.75). A nickel sintered substrate is immersed into the aqueous nickel nitrate solution at 80° C. to impregnate pores in the substrate with the nitrate salts.

### (b) Alkali-Treating (Forming Active Material)

Forming an active material is performed by immersing the nickel sintered substrate in an aqueous sodium hydroxide solution having a concentration of 8.0 mol/l at a temperature of 80° C. to convert the nitrate salts precipitated in the pores in the nickel sintered substrate into hydroxides.

### (c) Adjusting Alkali Amount

The nickel sintered substrate is immersed in a water bath for 16 seconds to adjust the alkali amount in the electrode sheet.

### (d) Heating

The electrode sheet is subjected to heating at a surrounding temperature of from 100 to 130° C. for 60 minutes.

### (e) Washing

The electrode sheet is immersed in a water bath for only 60 minutes to remove an alkali residue.

(2) Sintered Nickel Positive Electrode a2

The nickel sintered substrate β coated with the high order oxide layer of nickel and cobalt was used in the treatment steps (a) to (e). First, step (a), step (b), and step (e) were repeated twice, and then step (a), step (b), step (c), step (d), and step (e) were carried out once in this order to fill the pores in the nickel sintered substrate β with a particular amount of the positive electrode active material. Subsequently, the nickel sintered substrate was dried at 80° C. for 60 minutes to prepare a sintered nickel positive electrode with the pores in the nickel sintered substrate β filled with the positive electrode active material. The sintered nickel positive electrode thus obtained was regarded as a sintered nickel positive electrode a2.

(3) Sintered Nickel Positive Electrode a3

The nickel sintered substrate β coated with the high order oxide layer of nickel and cobalt was used in the treatment steps (a) to (e). First, step (a), step (b), step (c), step (d), and step (e) were carried out once in this order, and then step (a), step (b), and step (e) were repeated twice to fill the pores in the nickel sintered substrate β with a particular amount of the positive electrode active material. Subsequently, the substrate was dried at 80° C. for 60 minutes to prepare a sintered nickel positive electrode with the pores in the nickel sintered substrate β filled with the positive electrode active material. The sintered nickel positive electrode thus obtained was regarded as a sintered nickel positive electrode a3.

(4) Sintered Nickel Positive Electrode a4

The nickel sintered substrate β coated with the high order oxide layer of nickel and cobalt was used in the treatment steps (a) to (e). Step (a), step (b), and step (e) were repeated three times in this order to fill the pores in the nickel sintered substrate β with a particular amount of the positive electrode active material. Subsequently, the substrate was dried at 80° C. for 60 minutes to prepare a sintered nickel positive electrode with the pores in the nickel sintered substrate β filled with the positive electrode active material. The sintered nickel positive electrode thus obtained was regarded as a sintered nickel positive electrode a4.

(5) Sintered Nickel Positive Electrode b1

Next, using the nickel sintered substrate f3 coated with the high order oxide layer of nickel and cobalt, the treatment steps (a) to (e) were repeated a particular number of times (in this case, five times) to fill the pores in the nickel sintered substrate β with a particular amount of the positive electrode active material. Subsequently, the nickel sintered substrate was dried at 80° C. for 60 minutes and then was subjected to the treatment steps (f) to (j) below to prepare a sintered nickel positive electrode in which the pores in the nickel sintered substrate β were filled with a particular amount of the active material and a composite compound layer of an yttrium compound and nickel hydroxide was formed on the outermost face of the nickel sintered substrate. The sintered nickel positive electrode thus obtained was regarded as a sintered nickel positive electrode b1.

The treatment steps (f) to (j) are as follows.

(f) First, nickel nitrate and yttrium nitrate are mixed at a molar ratio of 1:1 to prepare an aqueous nickel nitrate solution (a specific gravity of 1.23). A nickel sintered substrate β is immersed into the aqueous nickel nitrate solution at 25° C., to impregnate the pores in the nickel sintered substrate β that have been filled with a particular amount of the active material with the nitrate salts.
(g) Subsequently, forming an active material is performed by immersing the nickel sintered substrate β in an aqueous sodium hydroxide solution having a concentration of 8.0 mol/l at a temperature of 80° C. to convert nitrate salts precipitated in the pores in the nickel sintered substrate β into hydroxides.
(h) The nickel sintered substrate is immersed in a water bath for 16 seconds to adjust the alkali amount in the nickel sintered substrate β.
(i) The substrate is subjected to heating at a surrounding temperature of from 100 to 130° C. for 60 minutes.
(j) The substrate is immersed in a water bath for only 60 minutes to remove the alkali residue, followed by drying at 80° C. for 60 minutes.
(6) Sintered Nickel Positive Electrode b2

Using the nickel sintered substrate β coated with the high order oxide layer of nickel and cobalt, step (a), step (b), and step (e) among the treatment steps (a) to (e) were repeated five times. Subsequently, step (f), step (g), step (h), step (i), and step (j) were carried out in this order to prepare a sintered nickel positive electrode in which the pores in the nickel sintered substrate β were filled with the positive electrode active material and a composite compound layer of an yttrium compound and nickel hydroxide was formed on the outermost face of the nickel sintered substrate. The sintered nickel positive electrode thus obtained was regarded as a sintered nickel positive electrode b2.

(7) Sintered Nickel Positive Electrode b3

Using the nickel sintered substrate β coated with the high order oxide layer of nickel and cobalt, step (a), step (b), and step (e) among the treatment steps (a) to (e) were repeated five times. Subsequently, step (f), step (g), and step (j) were carried out in this order to prepare a sintered nickel positive electrode in which the pores in the nickel sintered substrate β were filled with the positive electrode active material and a composite compound layer of an yttrium compound and nickel hydroxide was formed on the outermost face of the nickel sintered substrate. The sintered nickel positive electrode thus obtained was regarded as a sintered nickel positive electrode b3.

3. Integrated Intensity Ratio by X-Ray Diffraction Analysis

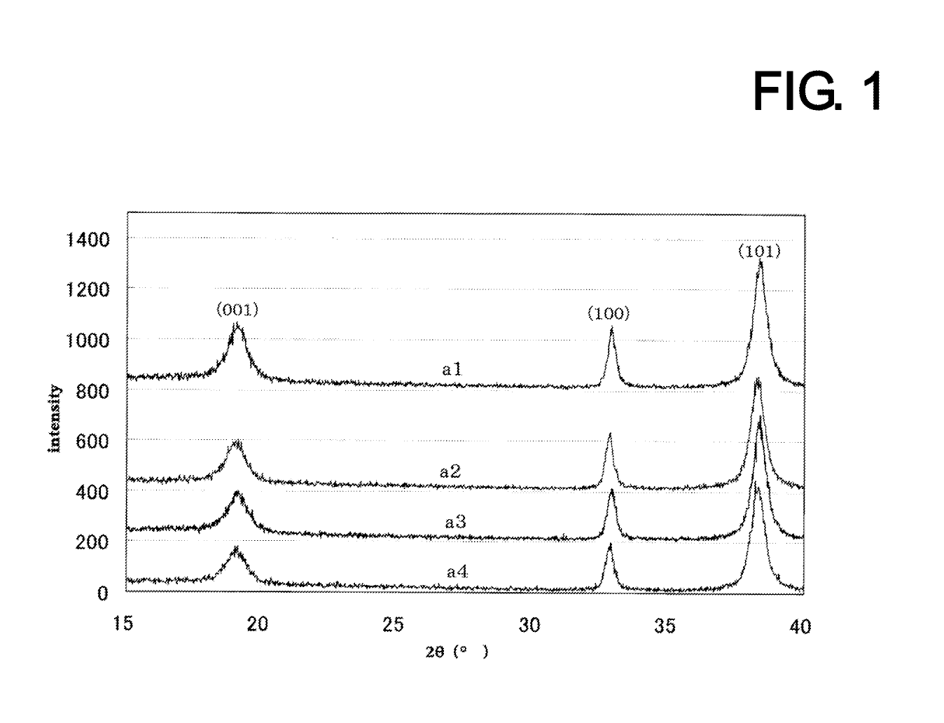

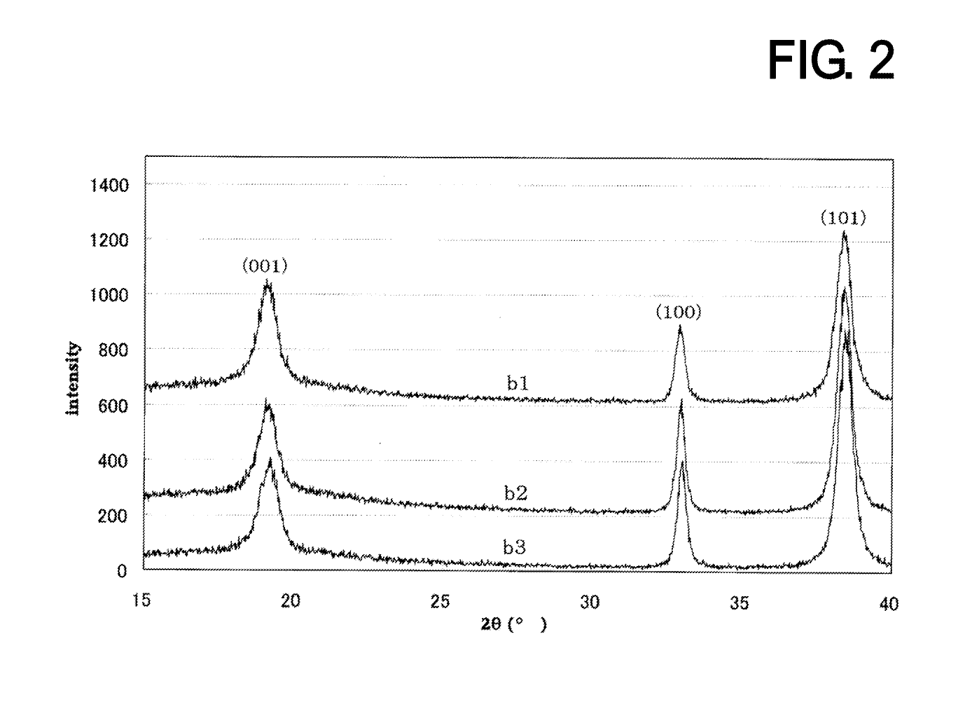

The sintered nickel positive electrodes a1 to a4 and b1 to b3 prepared as above were subjected to X-ray diffraction analysis with an X-ray diffractometer using a Cu—Kα radiation source (analysis condition: using a copper (Cu) tube at a tube voltage of 30 KV, a tube current of 12 mA, and a scan speed of 3 deg/min). FIGS. 1 and 2 show the results. Based on the results obtained, the integrated intensity ratio of the peak intensity in the (001) face with respect to the peak intensity in the (100) face in each β-Ni(OH)₂ was calculated. Table 1 shows the results obtained.

4. Battery Test with Simple Cell

Next, the sintered nickel positive electrodes a1 to a4 and b1 to b3 prepared as above were cut into a particular size. The sintered nickel positive electrode having been cut and a metal nickel as a counter electrode were used while a separator was interposed therebetween, and then 8.0 mol of potassium hydroxide (KOH) electrolyte was poured to prepare each of the simple cells A1 to A4 and B1 to B3. Here, the cell using the sintered nickel positive electrode a1 was regarded as a simple cell A1. In a similar manner, the cell using the positive electrode a2 was regarded as a simple cell A2, the cell using the positive electrode a3 as a simple cell A3, and the cell using the positive electrode a4 as a simple cell A4. The cell using the positive electrode b1 was regarded as a simple cell B1, the cell using the positive electrode b2 as a simple cell B2, and the cell using the positive electrode b3 as a simple cell B3.

Next, the simple cells A1 to A4 and B1 to B3 prepared as above were charged at 0.5 It to 110% of electrode sheet capacity of corresponding positive electrodes a1 to a4 and b1 to b3, and were then subjected to discharge at 1.0 It until each electric potential of the positive electrodes a1 to a4 and b1 to b3 reached −1.0 V (with respect to mercuric oxide electrode). This charging-discharging cycle (activation treatment) was repeated three times. Subsequently, the cells were charged to 50% of the electrode sheet capacity of corresponding positive electrodes a1 to a4 and b1 to b3, and were then subjected to discharge at a discharging current of 1 It until each electric potential reached −1.0 V (with respect to mercuric oxide electrode). The discharge capacity was calculated as continuous discharge characteristics at 1 It (low rate). Table 1 shows the results obtained.

Next, the remaining electricity of each cell was discharged at a discharging current of 0.5 It until each electric potential reached −1.0 V (with respect to mercuric oxide electrode). Next, the cells were charged once again to 50% of the electrode sheet capacity of corresponding positive electrodes a1 to a4 and b1 to b3, and were then subjected to discharge at a discharging current of 30 It until each electric potential reached −1.0 V (with respect to mercuric oxide electrode). The discharge capacity at 30 It was calculated as continuous discharge characteristics at 30 It (high rate). Table 1 shows the results obtained. In Table 1, the 1-It (low-rate) continuous discharge characteristics and the 30-It (high-rate) continuous discharge characteristics of the positive electrodes a1 to a4 (without an Y-containing coating layer) were determined where the discharge characteristics result of the simple cell A2 was regarded as 100, and those of the positive electrodes b1 to b3 (with an Y-containing coating layer) were calculated where the discharge characteristics result of the simple cell B2 was regarded as 100.

TABLE 1

| | | X-ray integrated | 1 lt (low rate) | 30 lt (high rate) |
|---|---|---|---|---|
| | Presence or absence of | intensity ratio | continuous | continuous |
| Cell | Y-containing coating | (001) face/(100) | discharge | discharge |
| type | layer | face | characteristics | characteristics |
| A1 | Absent | 1.8 | 100 | 111 |
| A2 | Absent | 1.6 | 100 | 100 |
| A3 | Absent | 1.6 | 99 | 102 |
| A4 | Absent | 1.5 | 99 | 97 |
| B1 | Present | 2.5 | 100 | 113 |
| B2 | Present | 1.5 | 100 | 100 |
| B3 | Present | 1.6 | 96 | 82 |

As apparent from the results in Table 1, the sintered nickel positive electrodes having an integrated intensity ratio of the peak intensity in the (001) face of 1.8 or more with respect to the peak intensity in the (100) face that was determined by X-ray diffraction analysis of nickel hydroxide (β-Ni(OH)₂) had improved high-rate continuous discharge characteristics among the sintered nickel positive electrodes that were filled with a positive electrode active material containing nickel hydroxide (β-Ni(OH)₂) as a main component, regardless of the presence or absence of the Y-containing coating layer.

This is thought to have occurred because protons could readily move even in a low charging region due to the crystal structure of nickel hydroxide (β-Ni(OH)₂) being different from a normal crystal structure throughout the active material layer, in other words, due to the increase in the peak intensity in the (001) face with respect to the peak intensity in the (100) face, thereby improving reactivity in a low charging region and improving high-rate continuous discharge capacity.

### INDUSTRIAL APPLICABILITY

The sintered nickel positive electrode of the invention can be applied to various alkaline storage batteries, such as a nickel-hydrogen storage battery including a hydrogen storage alloy negative electrode using a hydrogen storage alloy as a negative electrode active material and a nickel-cadmium storage battery including a cadmium negative electrode using cadmium hydroxide or cadmium oxide as a negative electrode active material.

### EXPLANATIONS OF LETTERS OR NUMERALS

a1, a2, a3, a4 types of a sintered nickel positive electrode with no Y-containing coating layer
b1, b2, b3 types of a sintered nickel positive electrode with an Y-containing coating layer

1. A sintered nickel positive electrode comprising:
a nickel sintered substrate filled, through a plurality of impregnation steps, with a positive electrode active material containing nickel hydroxide (β-Ni(OH)₂) as a main component,
the nickel hydroxide (β-Ni(OH)₂) having an integrated intensity ratio of a peak intensity in a (001) face of 1.8 or more with respect to a peak intensity in a (100) face, where the peak intensities are determined by X-ray diffraction analysis.

2. A method for manufacturing a sintered nickel positive electrode of filling a nickel sintered substrate with a positive electrode active material containing nickel hydroxide (β-Ni(OH)₂) as a main component through a plurality of impregnation steps in a nitrate salt solution, the method comprising:
impregnating pores in the nickel sintered substrate with a nitrate salt by immersing the nickel sintered substrate in the nitrate salt solution;
alkali-treating the nickel sintered substrate impregnated with the nitrate salt to convert the nitrate salt into nickel hydroxide (β-Ni(OH)₂) as an active material;
adjusting the alkali amount of the nickel sintered substrate alkali-treated; and
heating the nickel sintered substrate having the alkali amount adjusted to convert the nickel hydroxide as the active material into a high-order compound,
a series of steps of the impregnating, the alkali-treating, the adjusting of the alkali amount, and the heating being repeated until a particular amount of the active material is filled.

3. The method for manufacturing a sintered nickel positive electrode according to claim 2, wherein the adjusting of the alkali amount is performed by immersing the nickel sintered substrate after being alkali-treated in a water bath filled with water or in a water bath filled with an aqueous alkali solution having a particular concentration for a particular period of time.

4. An alkaline storage battery comprising:
an electrode group that includes a positive electrode, a negative electrode, and a separator; and
an alkaline electrolyte,
the electrode group being housed with the alkaline electrolyte in a battery casing sealed up,
the positive electrode being the sintered nickel positive electrode for an alkaline storage battery according to claim 1.
